(19) United States
(12) Patent Application Publication
(10) Pub. No.: US 2024/0179699 A1
(43) Pub. Date: May 30, 2024

(54) CONTROL METHOD OF ELECTRONIC DEVICE FOR LONG-RANGE BEACON

(71) Applicant: MEDIATEK INC., Hsin-Chu (TW)

(72) Inventors: Ming-Yen Tsai, Hsinchu City (TW); Tsung-Hsuan Wu, Hsinchu City (TW); Ching-Yu Kuo, Hsinchu City (TW)

(73) Assignee: MEDIATEK INC., Hsin-Chu (TW)

(21) Appl. No.: 18/520,562

(22) Filed: Nov. 28, 2023

Related U.S. Application Data
(60) Provisional application No. 63/385,044, filed on Nov. 28, 2022.

(51) Int. Cl. H04W 72/1263; H04W 72/0446; H04W 72/20; H04W 72/54

(52) U.S. Cl. CPC H04W 72/1263; H04W 72/0446; H04W 72/20; H04W 72/54

(57) ABSTRACT

The present invention provides a control method of an electronic device, wherein the control method includes the steps of: using a first beacon setting to transmit beacons; if a wireless communication state of the electronic device satisfies a condition, using a second beacon setting to transmit beacons; wherein the first beacon setting and the second beacon setting have different beacon periods or different payload sizes.

### CROSS REFERENCE TO RELATED APPLICATIONS

This application claims the benefit of U.S. Provisional Application No. 63/385,044, filed on Nov. 28, 2022. The content of the application is incorporated herein by reference.

### BACKGROUND

In order to wirelessly communicate with electronic devices at a greater distance, an access point may transmit a long-range beacon with lower data rate periodically. However, because the long-range beacon is transmitted with the lower data rate, a longer air time will be taken up in packet transmission, thus affecting the packet transmission of other electronic devices.

### SUMMARY

It is therefore an objective of the present invention to provide a control method of the access point, which can use different beacon settings in different situations, to solve the above-mentioned problems.

According to one embodiment of the present invention, a control method of an electronic device comprises the steps of: using a first beacon setting to transmit beacons; if a wireless communication state of the electronic device satisfies a condition, using a second beacon setting to transmit beacons; wherein the first beacon setting and the second beacon setting have different beacon periods or different payload sizes.

According to one embodiment of the present invention, an electronic device comprising a processing circuit and a wireless communication module is disclosed. The electronic device is configured to perform the steps of: using a first beacon setting to transmit beacons; if a wireless communication state of the electronic device satisfies a condition, using a second beacon setting to transmit beacons; wherein the first beacon setting and the second beacon setting have different beacon periods or different payload sizes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to one embodiment of the present invention.

FIG. 2 is a flowchart of a control method of the access point according to one embodiment of the present invention.

FIG. 3 is a diagram illustrating a first beacon setting according to one embodiment of the present invention.

FIG. 4 is a diagram illustrating a second beacon setting according to one embodiment of the present invention.

FIG. 5 is a flowchart of a control method of the access point according to one embodiment of the present invention.

FIG. 6 is a diagram illustrating a first beacon setting according to one embodiment of the present invention.

FIG. 7 is a diagram illustrating a second beacon setting according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

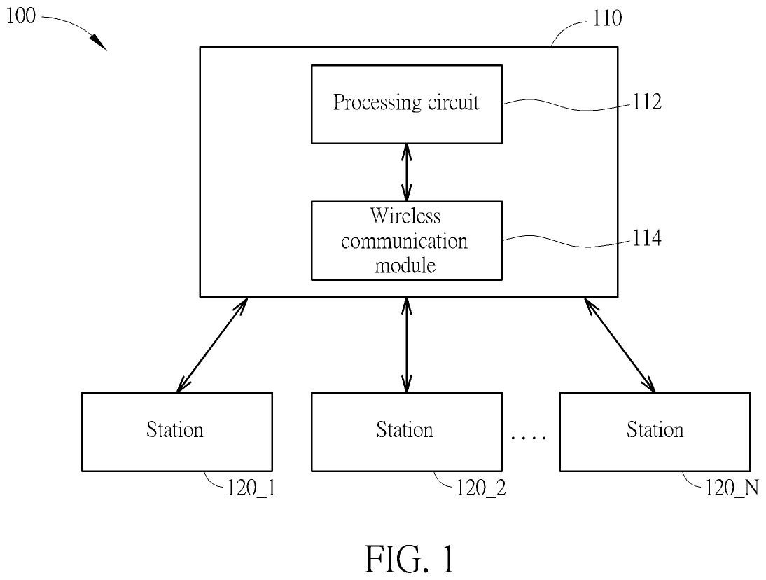

FIG. 1 is a diagram illustrating a wireless communication system 100 according to one embodiment of the present invention. As shown in FIG. 1, the wireless communication system 100 comprises an access point (AP) 110 and a plurality of stations 120_1-120_N, wherein the stations 120_1-120_N are capable of wirelessly communicated with the AP 110. In addition, the AP 110 comprises a processing circuit 112 and a wireless communication module 114, wherein the wireless communication module 114 comprises a medium access control (MAC) layer circuitry and a physical layer circuitry. In this embodiment, each of the stations 120_1-120_N is a Wi-Fi station comprising a processing circuit and a wireless communication module, and the station 120 can be a cell phone, a tablet, a notebook, an Internet of Things (IOT) device, or any other electronic device capable of wirelessly communicating with the AP 110.

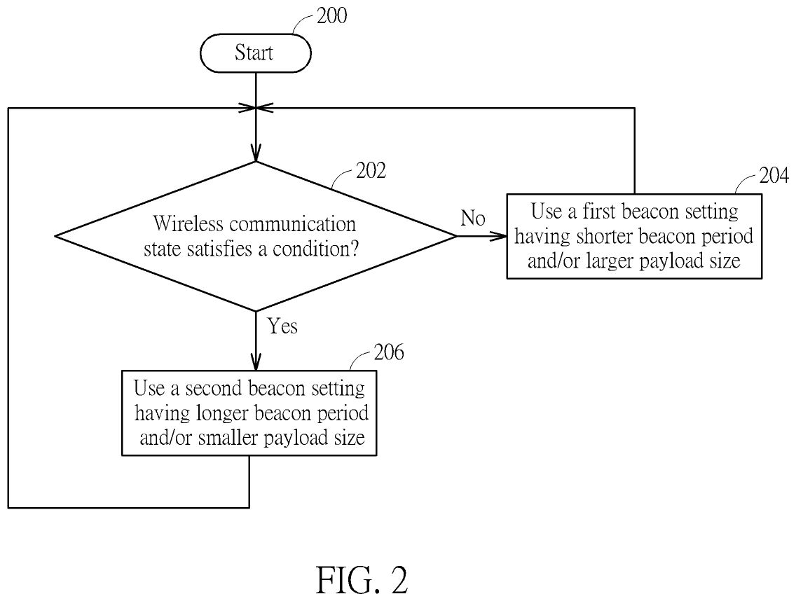

FIG. 2 is a flowchart of a control method of the AP 110 according to one embodiment of the present invention. In Step 200, the flow starts, and the AP 110 is powered on and temporarily at an idle state (e.g., the AP 110 does not wirelessly communicate with any electronic device). In Step 202, the wireless communication module 114 determines if a wireless communication state of the AP 110 satisfies a condition, for example, the wireless communication module 114 determines if one or more stations or specific stations are successfully connected to the AP 110, if yes, the flow enters Step 206; and if not, the flow enters Step 204. In this embodiment, the above specific station can be any device that only requires a low data rate, such as a wireless doorbell or a remote camera.

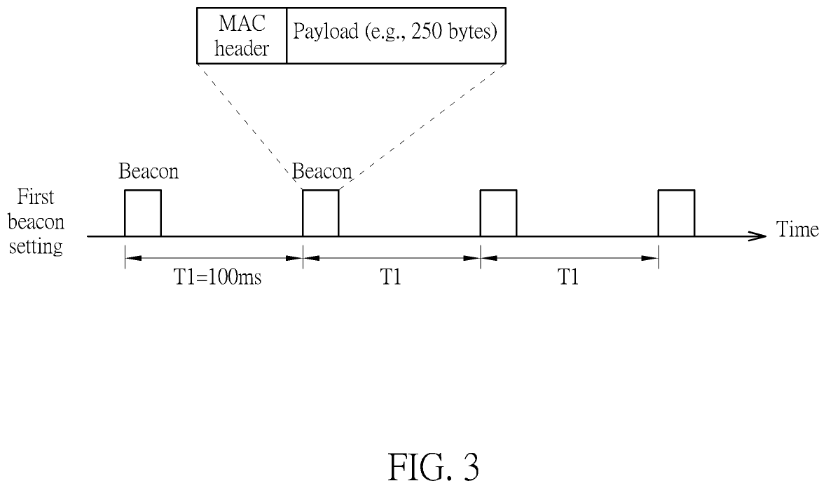

In Step 204, the wireless communication module 114 uses a first beacon setting to transmit the beacons periodically. Specifically, referring to FIG. 3, the wireless communication module 114 may use a shorter beacon period T1 to transmit the beacons periodically, wherein the beacon period T1 may be a normal beacon period such as 100 millisecond (ms). In addition, the beacon corresponding to the first beacon setting comprises the contents defined in IEEE 802.11 specification, and the beacon has a larger payload size such as 250 bytes. For example, the beacon corresponding to the first beacon setting may comprise a service set identifier (SSID), supported rates, traffic indication map (TIM), country information, power constraint, high efficient (HE) capabilities, HE operation, spatial reuse parameter set, enhanced distributed channel access (EDCA) parameter set, HE 6 GHz band capabilities, . . . etc.

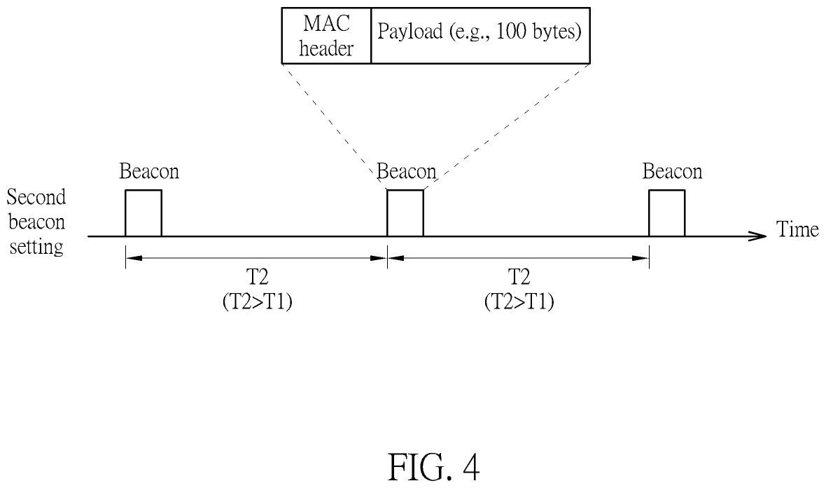

In Step 206, the wireless communication module 114 uses a second beacon setting to transmit the beacons periodically. Specifically, referring to FIG. 4, the wireless communication module 114 may use a longer beacon period T2 to transmit the beacons periodically, wherein the beacon period T2 is greater than the beacon period T1 corresponding to the first beacon setting. For example, the beacon period T2 may be 600 ms, 800 ms, 1000 ms or any suitable period greater than T1. In addition, the beacon corresponding to the second beacon setting comprises only part of the contents defined in IEEE 802.11 specification, and the beacon has a smaller payload size such as 100 bytes. For example, the beacon corresponding to the second beacon setting may comprise a SSID, supported rates, TIM, country information, power constraint, . . . etc., but the beacon corresponding to the second beacon setting does not have the power-efficient and/or high-throughput related information such as HE capabilities, HE operation, spatial reuse parameter set, enhanced distributed channel access (EDCA) parameter set, HE 6 GHz band capabilities, . . . etc.

In the above embodiments shown in FIG. 3 and FIG. 4, the first beacon setting and the second beacon setting have different beacon periods and different payloads. However, in other embodiments, the first beacon setting and the second beacon setting may have different beacon periods but the same payloads, or the first beacon setting and the second beacon setting have different payloads but the same beacon periods. These alternative designs shall fall within the scope of the present invention.

In one embodiment, the beacons mentioned above are transmitted under a smaller data rate that is lower than a basic bandwidth unit (e.g. 20 Mbps) of Wi-Fi. For example, the beacons in FIG. 3 and FIG. 4 may be transmitted under the data rate equal to 0.375 Mbps. In addition, as mentioned in the background of the present invention, because the beacon is transmitted with the lower data rate, a longer air time will be taken up in packet transmission, thus affecting the packet transmission of other electronic devices. Therefore, by using the second beacon setting having longer beacon period and smaller payload size when the AP 110 is wirelessly connected to one or more stations, the air time occupied by the beacons can be greatly reduced, to avoid affecting packet transmission of other electronic devices.

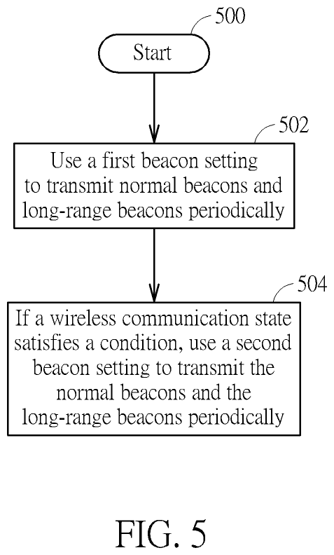

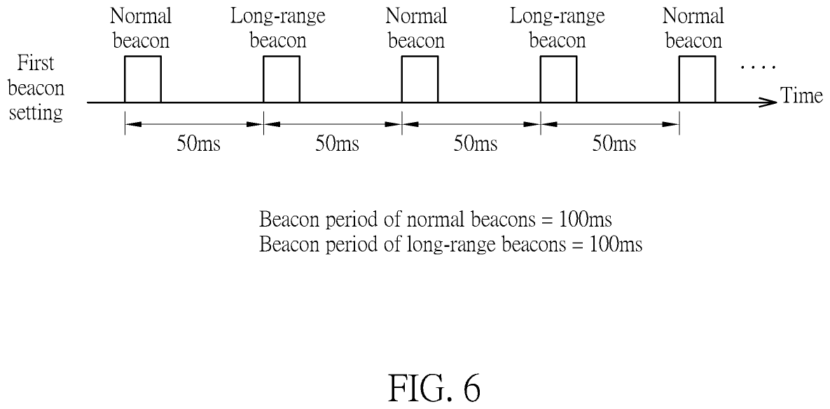

FIG. 5 is a flowchart of a control method of the AP 110 according to one embodiment of the present invention. In Step 500, the flow starts, and the AP 110 is powered on and temporarily at an idle state (e.g., the AP 110 does not wirelessly communicate with any electronic device). In Step 502, the wireless communication module 114 configures a first beacon setting, and uses the first beacon setting to transmit beacons periodically, wherein the beacons comprise first-type beacons and second-type beacons. In the following description, the first-type beacon is a normal beacon defined in IEEE 802.11 specification, and the second-type beacon is a long-range beacon, wherein the normal beacon is transmitted with a higher data rate (e.g., greater than 20 Mbps), and the long-range beacon is transmitted with a lower data rate (e.g., lower than 20 Mbps, such as 0.375 Mbps). Specifically, referring to FIG. 6, the wireless communication module 114 may use a shorter beacon period such as 100 ms to transmit the normal beacons and the long-range beacons periodically, and the normal beacons and the long-range beacons are transmitted alternately. In addition, the beacon corresponding to the first beacon setting comprises the contents defined in IEEE 802.11 specification, and the beacon has a larger payload size such as 250 bytes. For example, the normal beacon or the long-range beacon corresponding to the first beacon setting may comprise a SSID, supported rates, TIM, country information, power constraint, HE capabilities, HE operation, spatial reuse parameter set, EDCA parameter set, HE 6 GHz band capabilities, . . . etc.

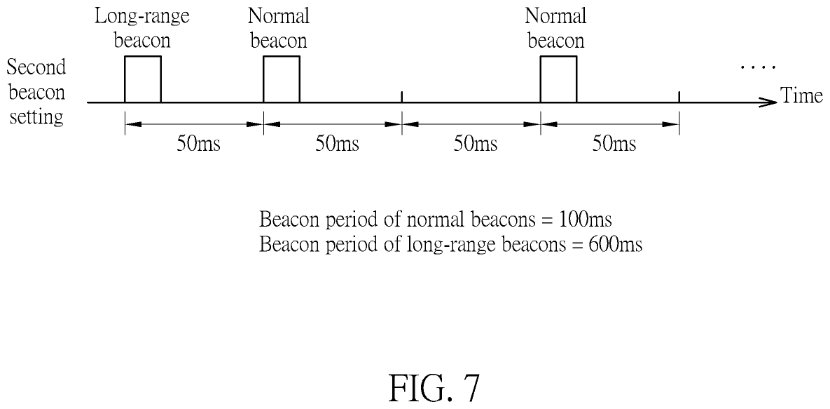

In Step 504, if a wireless communication state of the AP 110 satisfies a condition (e.g., if one or more stations or specific stations are successfully connected to the AP 110), the wireless communication module 114 configures a second beacon setting, and uses the second beacon setting to transmit the normal beacons and the long-range beacons periodically, wherein the above specific station can be any device that only requires a low data rate, such as a wireless doorbell or a remote camera. Specifically, referring to FIG. 7, the wireless communication module 114 may use a shorter beacon period such as 100 ms to transmit the normal beacons periodically, and use a longer beacon period to transmit the long-range beacons periodically, wherein the longer beacon period may be 600 ms, 800 ms, 1000 ms or any suitable period greater than 100 ms. In addition, the normal beacon corresponding to the second beacon setting has the same content as the normal beacon corresponding to the first beacon setting, the long-range beacon corresponding to the second beacon setting comprises only part of the contents defined in IEEE 802.11 specification, and the long-range beacon has a smaller payload size such as 100 bytes. For example, the long-range beacon corresponding to the second beacon setting may comprise a SSID, supported rates, TIM, country information, power constraint, . . . etc., but the long-range beacon corresponding to the second beacon setting does not have the power-efficient and/or high-throughput related information such as HE capabilities, HE operation, spatial reuse parameter set, enhanced distributed channel access (EDCA) parameter set, HE 6 GHz band capabilities, . . . etc.

In the above embodiments shown in FIG. 6 and FIG. 7, the first beacon setting and the second beacon setting have different beacon periods and different payload sizes for the long-range beacons. However, in other embodiments, the first beacon setting and the second beacon setting may have different beacon periods but the same payload sizes for the long-range beacons, or the first beacon setting and the second beacon setting have different payload sizes but the same beacon periods for the long-range beacons. These alternative designs shall fall within the scope of the present invention.

Briefly summarized, in the control method of the AP of the present invention, by using the second beacon setting having longer beacon period and/or smaller size when the AP is wirelessly connected to one or more stations, the air time occupied by the beacons can be greatly reduced, to avoid affecting packet transmission of other electronic devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of an electronic device, comprising:
using a first beacon setting to transmit beacons;
if a wireless communication state of the electronic device satisfies a condition, using a second beacon setting to transmit beacons;
wherein the first beacon setting and the second beacon setting have different beacon periods or different payload sizes.

2. The control method of claim 1, wherein the first beacon setting and the second beacon setting have different beacon periods, and a beacon period corresponding to the second beacon setting is longer than a beacon period corresponding to the first beacon setting.

3. The control method of claim 1, wherein the step of using the second beacon setting to transmit beacons comprises:
if one or more stations or specific stations are connected to the electronic device, using the second beacon setting to transmit beacons.

4. The control method of claim 1, wherein the first beacon setting and the second beacon setting have different payload sizes, and a payload size of a beacon corresponding to the second beacon setting is smaller than a payload size of a beacon corresponding to the first beacon setting.

5. The control method of claim 4, wherein the beacon corresponding to the first beacon setting comprises power-efficient and/or high-throughput information, and the beacon corresponding to the second beacon setting does not comprise the power-efficient and/or high-throughput information.

6. The control method of claim 1, wherein the step of using the first beacon setting to transmit the beacons comprises:
using the first beacon setting to transmit first-type beacons and second-type beacons alternately; and
the step of using the second beacon setting to transmit the beacons comprises:
using the second beacon setting to transmit first-type beacons and second-type beacons;
wherein a beacon period of the second-type beacons corresponding to the second beacon setting is longer than a beacon period of the second-type beacons corresponding to the first beacon setting.

7. The control method of claim 6, wherein a beacon period of the first-type beacons corresponding to the second beacon setting is the same as a beacon period of the first-type beacons corresponding to the first beacon setting.

8. The control method of claim 6, wherein a payload size of each second-type beacon corresponding to the second beacon setting is smaller than a payload size of each second-type beacon corresponding to the first beacon setting.

9. The control method of claim 8, wherein the second-type beacon corresponding to the first setting beacon comprises power-efficient and/or high-throughput information, and the second-type beacon corresponding to the second beacon setting does not comprise the power-efficient and/or high-throughput information.

10. The control method of claim 6, wherein a data rate of the first-type beacons corresponding to the first beacon setting and the second beacon setting is lower than a data rate of the second-type beacons corresponding to the first beacon setting and the second beacon setting.

11. An electronic device comprising a processing circuit and a wireless communication module, configured to perform the steps of:
using a first beacon setting to transmit beacons;
if a wireless communication state of the electronic device satisfies a condition, using a second beacon setting to transmit beacons;
wherein the first beacon setting and the second beacon setting have different beacon periods or different payload sizes.

12. The electronic device of claim 11, wherein the first beacon setting and the second beacon setting have different beacon periods, and a beacon period corresponding to the second beacon setting is longer than a beacon period corresponding to the first beacon setting.

13. The electronic device of claim 11, wherein the step of using the second beacon setting to transmit beacons comprises:
if one or more stations or specific stations are connected to the electronic device, using the second beacon setting to transmit beacons.

14. The electronic device of claim 11, wherein the first beacon setting and the second beacon setting have different payload sizes, and a payload size of a beacon corresponding to the second beacon setting is smaller than a payload size of a beacon corresponding to the first beacon setting.

15. The electronic device of claim 14, wherein the beacon corresponding to the first beacon setting comprises power-efficient and/or high-throughput information, and the beacon corresponding to the second beacon setting does not comprise the power-efficient and/or high-throughput information.

16. The electronic device of claim 11, wherein the step of using the first beacon setting to transmit the beacons comprises:
using the first beacon setting to transmit first-type beacons and second-type beacons alternately; and
the step of using the second beacon setting to transmit the beacons comprises:
using the second beacon setting to transmit first-type beacons and second-type beacons;
wherein a beacon period of the second-type beacons corresponding to the second beacon setting is longer than a beacon period of the second-type beacons corresponding to the first beacon setting.

17. The electronic device of claim 16, wherein a beacon period of the first-type beacons corresponding to the second beacon setting is the same as a beacon period of the first-type beacons corresponding to the first beacon setting.

18. The electronic device of claim 16, wherein a payload size of each second-type beacon corresponding to the second beacon setting is smaller than a payload size of each second-type beacon corresponding to the first beacon setting.

19. The electronic device of claim 18, wherein the second-type beacon corresponding to the beacon first setting comprises power-efficient and/or high-throughput information, and the second-type beacon corresponding to the second beacon setting does not comprise the power-efficient and/or high-throughput information.

20. The electronic device of claim 16, wherein a data rate of the first-type beacons corresponding to the first beacon setting and the second beacon setting is lower than a data rate of the second-type beacons corresponding to the first beacon setting and the second beacon setting.
